(19) United States
(12) Patent Application Publication
(10) Pub. No.: US 2008/0208594 A1
(43) Pub. Date: Aug. 28, 2008

(54) Effecting Functions On A Multimodal Telephony Device

(76) Inventors: Charles W. Cross, Wellington, FL (US); Frank L. Jania, Chapel Hill, NC (US); Darren M. Shaw, Fairham (GB)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/679,312

(22) Filed: Feb. 27, 2007

(51) Int. Cl. G10L 11/00

(52) U.S. Cl. 704/275

(57) ABSTRACT

Methods, apparatus, and computer program products are described for effecting functions on a multimodal telephony device, implemented with the multimodal application operating on a multimodal telephony device supporting multiple modes of interaction including a voice mode and one or more non-voice modes, the multimodal application operatively coupled to an automated speech recognition engine. Embodiments include receiving the speech of a telephone call; identifying with the automated speech recognition engine action keywords in the speech of the telephone call; selecting a function of the multimodal telephony device in dependence upon the action keywords; identifying parameters for the function of the multimodal telephony device; and executing the function of the multimodal telephony device using the identified parameters.

### BACKGROUND OF THE INVENTION

1. Field of the Invention

The field of the invention is data processing, or, more specifically, methods, apparatus, and products for effecting functions on a multimodal telephony device.

2. Description of Related Art

User interaction with applications running on small devices through a keyboard or stylus has become increasingly limited and cumbersome as those devices have become increasingly smaller. In particular, small handheld devices like mobile phones and PDAs serve many functions and contain sufficient processing power to support user interaction through multimodal access, that is, by interaction in non-voice modes as well as voice mode. Devices which support multimodal access combine multiple user input modes or channels in the same interaction allowing a user to interact with the applications on the device simultaneously through multiple input modes or channels. The methods of input include speech recognition, keyboard, touch screen, stylus, mouse, handwriting, and others. Multimodal input often makes using a small device easier.

Multimodal applications are often formed by sets of markup documents often served up by web servers for display on multimodal browsers. A ‘multimodal browser,’ as the term is used in this specification, generally means a web browser capable of receiving multimodal input and interacting with users with multimodal output, where modes of the multimodal input and output include at least a speech mode. Multimodal browsers typically render web pages written in XHTML+Voice (‘X+V’). X+V provides a markup language that enables users to interact with an multimodal application often running on a server through spoken dialog in addition to traditional means of input such as keyboard strokes and mouse pointer action. Visual markup tells a multimodal browser what the user interface is look like and how it is to behave when the user types, points, or clicks. Similarly, voice markup tells a multimodal browser what to do when the user speaks to it. For visual markup, the multimodal browser uses a graphics engine; for voice markup, the multimodal browser uses a speech engine. X+V adds spoken interaction to standard web content by integrating XHTML (eXtensible Hypertext Markup Language) and speech recognition vocabularies supported by VoiceXML. For visual markup, X+V includes the XHTML standard. For voice markup, X+V includes a subset of VoiceXML. For synchronizing the VoiceXML elements with corresponding visual interface elements, X+V uses events. XHTML includes voice modules that support speech synthesis, speech dialogs, command and control, and speech grammars. Voice handlers can be attached to XHTML elements and respond to specific events. Voice interaction features are integrated with XHTML and can consequently be used directly within XHTML content.

In addition to X+V, multimodal applications also may be implemented with Speech Application Tags (‘SALT’). SALT is a markup language developed by the Salt Forum. Both X+V and SALT are markup languages for creating applications that use voice input/speech recognition and voice output/speech synthesis. Both SALT applications and X+V applications use underlying speech recognition and synthesis technologies or ‘speech engines’ to do the work of recognizing and generating human speech. As markup languages, both X+V and SALT provide markup-based programming environments for using speech engines in an application's user interface. Both languages have language elements, markup tags, that specify what the speech-recognition engine should listen for and what the synthesis engine should ‘say.’ Whereas X+V combines XHTML, VoiceXML, and the XML Events standard to create multimodal applications, SALT does not provide a standard visual markup language or eventing model. Rather, it is a low-level set of tags for specifying voice interaction that can be embedded into other environments. In addition to X+V and SALT, multimodal applications may be implemented in Java with a Java speech framework, in C++, for example, and with other technologies and in other environments as well.

Current lightweight voice solutions require a developer to build a grammar and lexicon to limit the potential number of words that an automated speech recognition (‘ASR’) engine must recognize—as a means for increasing accuracy. Pervasive devices have limited interaction and input modalities due to the form factor of the device, and kiosk devices have limited interaction and input modalities by design. In both cases the use of speaker independent voice recognition is implemented to enhance the user experience and interaction with the device. The state of the art in speaker independent recognition allows for some sophisticated voice applications to be written as long as there is a limited vocabulary associated with each potential voice command. For example, if the user is prompted to speak the name of a city the system can, with a good level of confidence, recognize the name of the city spoken. Voice enabling multimodal applications, however, still remains computationally intensive, and providing dynamic changes among speech recognition grammars is still achieved primarily by reloading entire X+V pages.

### SUMMARY OF THE INVENTION

Methods, apparatus, and computer program products are described for effecting functions on a multimodal telephony device, implemented with the multimodal application operating on a multimodal telephony device supporting multiple modes of interaction including a voice mode and one or more non-voice modes, the multimodal application operatively coupled to an automated speech recognition engine.

Embodiments include receiving the speech of a telephone call; identifying with the automated speech recognition engine action keywords in the speech of the telephone call; selecting a function of the multimodal telephony device in dependence upon the action keywords; identifying parameters for the function of the multimodal telephony device; and executing the function of the multimodal telephony device using the identified parameters.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for effecting functions on a multimodal telephony device according to embodiments of the present invention.

FIG. 2 sets forth a block diagram of automated computing machinery comprising an example of a computer useful as a voice server for effecting functions on a multimodal telephony device according to embodiments of the present invention.

FIG. 3 sets forth a functional block diagram of exemplary system for effecting functions on a multimodal telephony device in a thin client architecture according to embodiments of the present invention.

FIG. 4 sets forth a block diagram of automated computing machinery comprising an example of a computer useful as a multimodal telephony device (152) capable of effecting functions on a multimodal telephony device according to embodiments of the present invention.

FIG. 5 sets forth a flow chart illustrating an exemplary method for effecting functions on a multimodal telephony device.

### DETAILED DESCRIPTION OF EXEMPLARY EMBODIMENTS

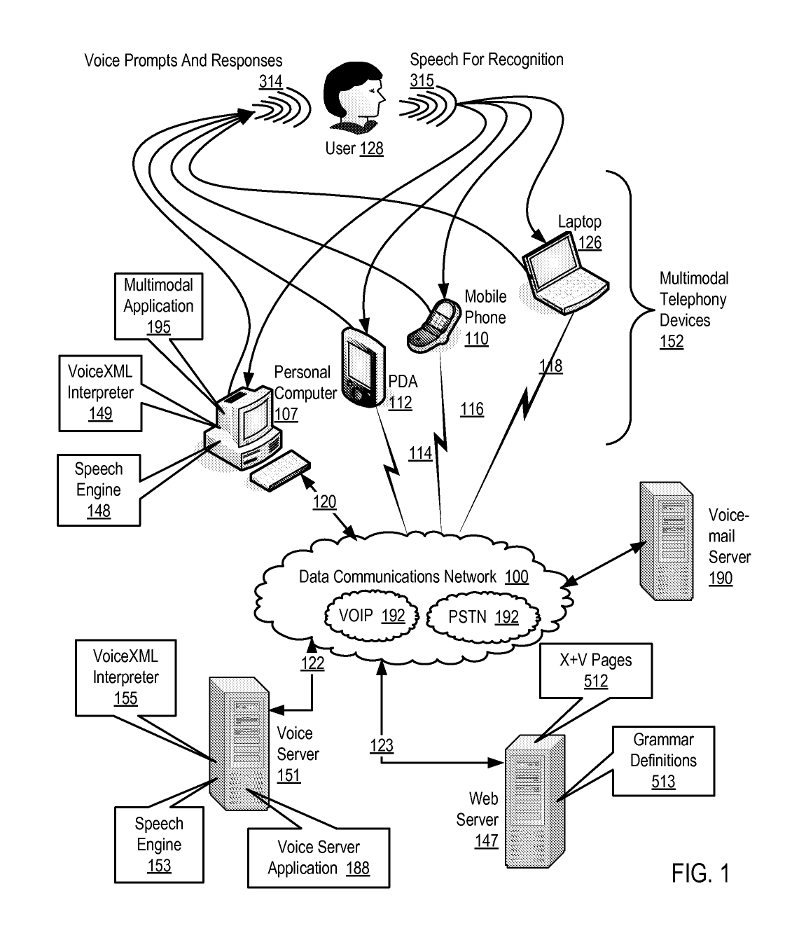

Exemplary methods, apparatus, and products for effecting functions on a multimodal telephony device according to embodiments of the present invention are described with reference to the accompanying drawings, beginning with FIG. 1. FIG. 1 sets forth a network diagram illustrating an exemplary system for effecting functions on a multimodal telephony device according to embodiments of the present invention. Effecting functions on a multimodal telephony device in this example is implemented with a multimodal application (195) operating on a multimodal telephony device (152). In this specification, ‘telephony’ means translating sound into electrical signals, transmitting those signals, and then converting the signals back to sound. That is, telephony means the broad science of telephone communications.

The multimodal telephony devices (152) of FIG. 1 support multiple modes of interaction including a voice mode and one or more non-voice modes. The voice mode is represented here with audio output of voice prompts and responses (177) from the multimodal devices and audio input of speech for recognition (315) from a user (128). Non-voice modes are represented by input/output devices such as keyboards and display screens on the multimodal devices (152). The multimodal application is operatively coupled to an automated speech recognition engine (148 or 153). The operative coupling may be implemented with an application programming interface (‘API’), a voice service module, or a VOIP connection as explained more detail below.

Each multimodal telephony device (152) of FIG. 1 supports various functions which may be effected in accordance with the present invention. Examples of such functions include storing a phonebook entry, storing an address book entry, determining an address, using a mapping function to map an address, composing or sending an email or text message, capturing or retrieving an image, storing directions to a location, setting a reminder alarm, storing a calendar entry, as well as others that will occur to those of skill in the art.

The system of FIG. 1 operates generally to effect functions on a multimodal telephony device according to embodiments of the present invention by receiving the speech of a telephone call; identifying with the automated speech recognition engine action keywords in the speech of the telephone call; selecting a function of the multimodal telephony device in dependence upon the action keywords; identifying parameters for the function of the multimodal telephony device; and executing the function of the multimodal telephony device using the identified parameters.

A multimodal telephony device is an automated device, that is, automated computing machinery or a computer program running on an automated device, that supports telephony and is also capable of accepting from users more than one mode of input, keyboard, mouse, stylus, and so on, including speech input—and also displaying more than one mode of output, graphic, speech, and so on. A multimodal telephony device is generally capable of accepting speech input from a user, digitizing the speech, and providing digitized speech to a speech engine for recognition. A multimodal telephony device may be implemented, for example, as a voice-enabled browser on a laptop that supports VOIP telephony services, a voice browser on a telephone handset, and with other combinations of hardware and software as may occur to those of skill in the art. Because multimodal applications may be implemented in markup languages (X+V, SALT), object-oriented languages (Java, C++), procedural languages (the C programming language), and in other kinds of computer languages as may occur to those of skill in the art, this specification uses the term ‘multimodal application’ to refer to any software application, server-oriented or client-oriented, thin client or thick client, that administers more than one mode of input and more than one mode of output, typically including visual and speech modes.

The system of FIG. 1 includes several example multimodal telephony devices:
personal computer (107) supporting VOIP (“Voice Over Internet Protocol”) telephony and which is coupled for data communications to data communications network (100) through wireline connection (120),
personal digital assistant (‘PDA’) (112) that supports cellular wireless telephone services and which is coupled for data communications to data communications network (100) through wireless connection (114),
mobile telephone (110) which is coupled for data communications to data communications network (100) through wireless connection (116), and
laptop computer (126) which supports VOIP telephony which is coupled for data communications to data communications network (100) through wireless connection (118).

Each of the example multimodal telephony devices (152) in the system of FIG. 1 includes a microphone, an audio amplifier, a digital-to-analog converter, and a multimodal application capable of accepting from a user (128) speech for recognition (315), digitizing the speech, and providing the digitized speech to a speech engine for recognition. The speech may be digitized according to industry standard codecs, including but not limited to those used for Distributed Speech Recognition as such. Methods for ‘COding/DECoding’ speech are referred to as ‘codecs.’ The European Telecommunications Standards Institute (‘ETSI’) provides several codecs for encoding speech for use in DSR, including, for example, the ETSI ES 201 108 DSR Front-end Codec, the ETSI ES 202 050 Advanced DSR Front-end Codec, the ETSI ES 202 211 Extended DSR Front-end Codec, and the ETSI ES 202 212 Extended Advanced DSR Front-end Codec. In standards such as RFC3557 entitled
RTP Payload Format for European Telecommunications Standards Institute (ETSI) European Standard ES 201 108 Distributed Speech Recognition Encoding
   and the Internet Draft entitled
RTP Payload Formats for European Telecommunications Standards Institute (ETSI) European Standard ES 202 050, ES 202 211, and ES 202 212 Distributed Speech Recognition Encoding,
   the IETF provides standard RTP payload formats for various codecs. It is useful to note, therefore, that there is no limitation in the present invention regarding codecs, payload formats, or packet structures. Speech for effecting functions on a multimodal telephony device according to embodiments of the present invention may be encoded with any codec, including, for example:
AMR (Adaptive Multi-Rate Speech coder)
ARDOR (Adaptive Rate-Distortion Optimized sound codeR),
Dolby Digital (A/52, AC3),
DTS (DTS Coherent Acoustics),
MP1 (MPEG audio layer-1),
MP2 (MPEG audio layer-2) Layer 2 audio codec (MPEG-1, MPEG-2 and non-ISO MPEG-2.5),
MP3 (MPEG audio layer-3) Layer 3 audio codec (MPEG-1, MPEG-2 and non-ISO MPEG-2.5),
Perceptual Audio Coding,
FS-1015 (LPC-10),
FS-1016 (CELP),
G.726 (ADPCM),
G.728 (LD-CELP),
G.729 (CS-ACELP),
GSM,
HILN (MPEG-4 Parametric audio coding), and
others as may occur to those of skill in the art.

As mentioned, a multimodal telephony device according to embodiments of the present invention is capable of providing speech to a speech engine for recognition. A speech engine is a functional module, typically a software module, although it may include specialized hardware also, that does the work of recognizing and generating or ‘synthesizing’ human speech. The speech engine implements speech recognition by use of a further module referred to in this specification as a ASR engine, and the speech engine carries out speech synthesis by use of a further module referred to in this specification as a text-to-speech (‘TTS’) engine. As shown in FIG. 1, a speech engine (148) may be installed locally in a multimodal telephony device (107) itself, or a speech engine (153) may be installed remotely with respect to the multimodal telephony device, across a data communications network (100) in a voice server (151). A multimodal telephony device that itself contains its own speech engine is said to implement a ‘thick multimodal client’ or ‘thick client,’ because the thick multimodal client device itself contains all the functionality needed to carry out speech recognition and speech synthesis—through API calls to speech recognition and speech synthesis modules in the multimodal telephony device itself with no need to send requests for speech recognition across a network and no need to receive synthesized speech across a network from a remote voice server. A multimodal telephony device that does not contain its own speech engine is said to implement a ‘thin multimodal client’ or simply a ‘thin client,’ because the thin multimodal client itself contains only a relatively thin layer of multimodal application software that obtains speech recognition and speech synthesis services from a voice server located remotely across a network from the thin client. For ease of explanation, only one (107) of the multimodal telephony devices (152) in the system of FIG. 1 is shown with a speech engine (148), but readers will recognize that any multimodal telephony device may have a speech engine according to embodiments of the present invention.

A multimodal application (195) in this example is capable of providing speech for recognition and text for speech synthesis to a speech engine through a VoiceXML interpreter (149, 155). A VoiceXML interpreter is a software module of computer program instructions that accepts voice dialog instructions from a multimodal application, typically in the form of a VoiceXML <form> element. The voice dialog instructions include one or more grammars, data input elements, event handlers, and so on, that advise the VoiceXML interpreter how to administer voice input from a user and voice prompts and responses to be presented to a user, including vocal help prompts. The VoiceXML interpreter administers such dialogs by processing the dialog instructions sequentially in accordance with a VoiceXML Form Interpretation Algorithm (‘FIA’). As shown in FIG. 1, a VoiceXML interpreter (149) may be installed locally in the multimodal telephony device (107) itself, or a VoiceXML interpreter (155) may be installed remotely with respect to the multimodal telephony device, across a data communications network (100) in a voice server (151). In a thick client architecture, a multimodal telephony device (152) includes both its own speech engine (148) and its own VoiceXML interpreter (149). The VoiceXML interpreter (149) exposes an API to the multimodal application (195) for use in providing speech recognition and speech synthesis for the multimodal application. The multimodal application is also capable of providing dialog instructions, VoiceXML <form> elements, grammars, input elements, event handlers, and so on, through the API to the VoiceXML interpreter, and the VoiceXML interpreter administers the speech engine on behalf of the multimodal application. In the thick client architecture, VoiceXML dialogs are interpreted by a VoiceXML interpreter on the multimodal device. In the thin client architecture, VoiceXML dialogs are interpreted by a VoiceXML interpreter on a voice server (151) located remotely across a data communications network (100) from the multimodal telephony device running the multimodal application (195).

The VoiceXML interpreter provides grammars, speech for recognition, and text prompts for speech synthesis to the speech engine, and the VoiceXML interpreter returns to the multimodal application speech engine output in the form of recognized speech, semantic interpretation results, and digitized speech for voice prompts. In a thin client architecture, the VoiceXML interpreter (155) is located remotely from the multimodal telephony client device in a voice server (151), the API for the VoiceXML interpreter is still implemented in the multimodal device, with the API modified to communicate voice dialog instructions, speech for recognition, and text and voice prompts to and from the VoiceXML interpreter on the voice server. For ease of explanation, only one (107) of the multimodal telephony devices (152) in the system of FIG. 1 is shown with a VoiceXML interpreter (149), but readers will recognize that any multimodal device may have a VoiceXML interpreter according to embodiments of the present invention. Each of the example multimodal telephony devices (152) in the system of FIG. 1 may be configured to effect functions supported by the multimodal telephony device by installing and running on the multimodal telephony device a multimodal application that effects functions on a multimodal telephony device according to embodiments of the present invention.

The use of these four example multimodal telephony devices (152) is for explanation only, not for limitation of the invention. Automated computing machinery capable of providing telephony communications, accepting speech from a user, providing the speech digitized to an ASR engine through a VoiceXML interpreter, and receiving and playing speech prompts and responses from the VoiceXML interpreter may be improved to function as a multimodal telephony device for effecting functions according to embodiments of the present invention.

The system of FIG. 1 also includes a voice server (151) which is connected to data communications network (100) through wireline connection (122). The voice server (151) is a computer that runs a speech engine (153) that provides voice recognition services for multimodal telephony devices by accepting requests for speech recognition and returning text representing recognized speech. Voice server (151) also provides speech synthesis, text to speech (‘TTS’) conversion, for voice prompts and voice responses (314) to user input in multimodal applications such as, for example, X+V applications, SALT applications, or Java voice applications.

The system of FIG. 1 includes a data communications network (100) that connects the multimodal telephony devices (152) and the voice server (151) for data communications. A data communications network for effecting functions on a multimodal telephony device according to embodiments of the present invention is a data communications data communications network composed of a plurality of computers that function as data communications routers connected for data communications with packet switching protocols. Such a data communications network may be implemented with optical connections, wireline connections, or with wireless connections. Such a data communications network may include intranets, internets, local area data communications networks (‘LANs’), and wide area data communications networks (‘WANs’). Such a data communications network may implement, for example:
a link layer with the Ethernet™ Protocol or the Wireless Ethernet™ Protocol,
a data communications network layer with the Internet Protocol (‘IP’),
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The system of FIG. 1 includes a data communications network (100) also connects the multimodal telephony devices (152) with a voicemail server (190). The data communications network (100) includes a circuit switched a Public Switched Telephone Network (‘PSTN’) and a packet switched Voice Over Internet Protocol Network (‘VOIP’). The voice mail server (190) of FIG. 1 manages voice mails for users of the multimodal telephony devices (152). Effecting functions on a multimodal telephony device according to the present invention includes receiving the speech of a telephone call and such speech of the telephone call may include the speech of a voice mail message stored on the voice mail server (190).

The system of FIG. 1 includes a web server (147) connected for data communications through wireline connection (123) to network (100) and therefore to the multimodal telephony devices (152). The web server (147) may be any server that provides to client devices markup documents that compose multimodal applications. The web server (147) typically provides such markup documents via a data communications protocol, HTTP, HDTP, WAP, or the like. That is, although the term ‘web’ is used to described the web server generally in this specification, there is no limitation of data communications between multimodal devices and the web server to HTTP alone. The markup documents also may be implemented in any markup language that supports non-speech display elements, data entry elements, and speech elements for identifying which speech to recognize and which words to speak, grammars, form elements, and the like, including, for example, X+V and SALT. A multimodal application in a multimodal telephony device then, upon receiving from the web sever (147) a markup document as part of a multimodal application, may execute speech elements by use of a VoiceXML interpreter (149) and speech engine (148) in the multimodal device itself or by use of a VoiceXML interpreter (155) and speech engine (153) located remotely from the multimodal device in a voice server (151).

The arrangement of the multimodal devices (152), the web server (147), the voice server (151), and the data communications network (100) making up the exemplary system illustrated in FIG. 1 are for explanation, not for limitation. Data processing systems useful for effecting functions on a multimodal telephony device according to various embodiments of the present invention may include additional servers, routers, other devices, and peer-to-peer architectures, not shown in FIG. 1, as will occur to those of skill in the art. Data communications networks in such data processing systems may support many data communications protocols in addition to those noted above. Various embodiments of the present invention may be implemented on a variety of hardware platforms in addition to those illustrated in FIG. 1.

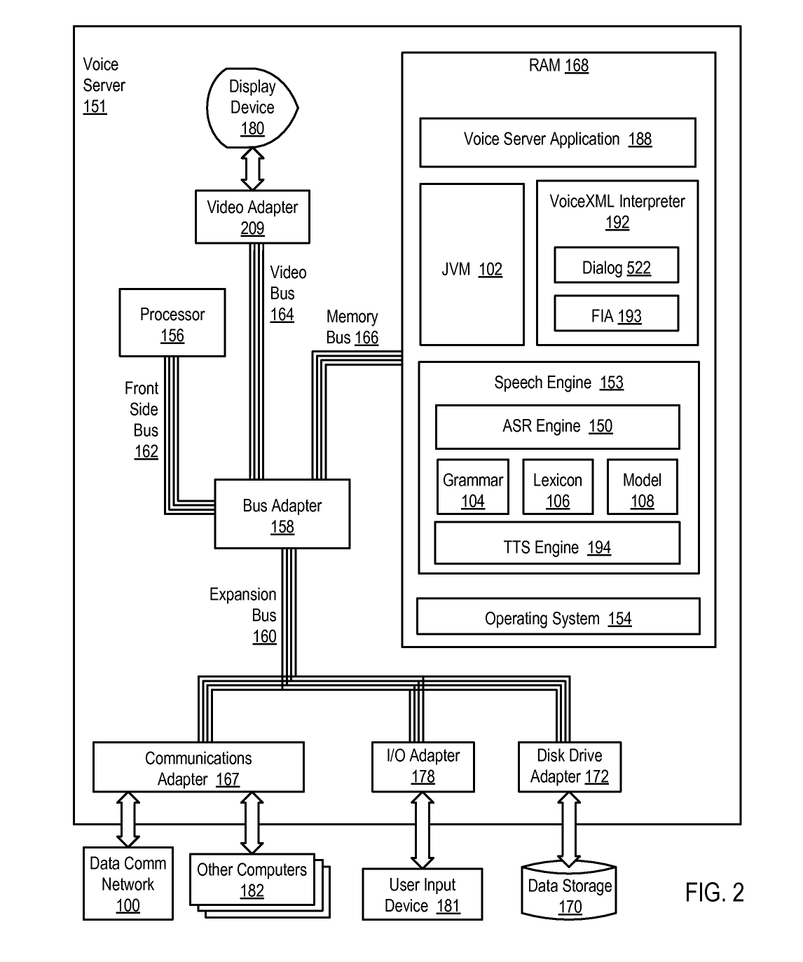

Effecting functions on a multimodal telephony device according to embodiments of the present invention in a thin client architecture may be implemented with one or more voice servers, computers, that is, automated computing machinery, that provide speech recognition and speech synthesis. For further explanation, therefore, FIG. 2 sets forth a block diagram of automated computing machinery comprising an example of a computer useful as a voice server (151) for effecting functions on a multimodal telephony device according to embodiments of the present invention. The voice server (151) of FIG. 2 includes at least one computer processor (156) or ‘CPU’ as well as random access memory (168) (‘RAM’) which is connected through a high speed memory bus (166) and bus adapter (158) to processor (156) and to other components of the voice server.

Stored in RAM (168) is a voice server application (188), a module of computer program instructions capable of operating a voice server in a system that is configured for use in effecting functions on a multimodal telephony device according to embodiments of the present invention. Voice server application (188) provides voice recognition services for multimodal telephony devices by accepting requests for speech recognition and returning speech recognition results, including text representing recognized speech, text for use as variable values in dialogs, and text as string representations of scripts for semantic interpretation. Voice server application (188) also includes computer program instructions that provide text-to-speech (‘TTS’) conversion for voice prompts and voice responses to user input in multimodal applications such as, for example, X+V applications, SALT applications, or Java Speech applications.

Voice server application (188) may be implemented as a web server, implemented in Java, C++, or another language, that supports X+V, SALT, VoiceXML, or other multimodal languages, by providing responses to HTTP requests from X+V clients, SALT clients, Java Speech clients, or other multimodal clients. Voice server application (188) may, for a further example, be implemented as a Java server that runs on a Java Virtual Machine (102) and supports a Java voice framework by providing responses to HTTP requests from Java client applications running on multimodal devices. And voice server applications that support effecting functions on a multimodal telephony device may be implemented in other ways as may occur to those of skill in the art, and all such ways are well within the scope of the present invention.

The voice server (151) in this example includes a speech engine (153). The speech engine is a functional module, typically a software module, although it may include specialized hardware also, that does the work of recognizing and generating human speech. The speech engine (153) includes an automated speech recognition (‘ASR’) engine for speech recognition and a text-to-speech (‘TTS’) engine for generating speech. The speech engine also includes a grammar (104), a lexicon (106), and a language-specific acoustic model (108). The language-specific acoustic model (108) is a data structure, a table or database, for example, that associates SFVs with phonemes representing, to the extent that it is practically feasible to do so, all pronunciations of all the words in a human language. The lexicon (106) is an association of words in text form with phonemes representing pronunciations of each word; the lexicon effectively identifies words that are capable of recognition by an ASR engine. Also stored in RAM (168) is a Text To Speech (‘TTS’) Engine (194), a module of computer program instructions that accepts text as input and returns the same text in the form of digitally encoded speech, for use in providing speech as prompts for and responses to users of multimodal systems.

The grammar (104) communicates to the ASR engine (150) the words and sequences of words that currently may be recognized. For precise understanding, distinguish the purpose of the grammar and the purpose of the lexicon. The lexicon associates with phonemes all the words that the ASR engine can recognize. The grammar communicates the words currently eligible for recognition. The set of words currently eligible for recognition and the set of words capable of recognition may or may not be the same.

Grammars for use in effecting functions on a multimodal telephony device according to embodiments of the present invention may be expressed in any format supported by any ASR engine, including, for example, the Java Speech Grammar Format (‘JSGF’), the format of the W3C Speech Recognition Grammar Specification (‘SRGS’), the Augmented Backus-Naur Format (‘ABNF’) from the IETF's RFC2234, in the form of a stochastic grammar as described in the W3C's Stochastic Language Models (N-Gram) Specification, and in other grammar formats as may occur to those of skill in the art. Grammars typically operate as elements of dialogs, such as, for example, a VoiceXML <menu> or an X+V<form>. A grammar's definition may be expressed in-line in a dialog. Or the grammar may be implemented externally in a separate grammar document and referenced from with a dialog with a URI. Here is an example of a grammar expressed in JSFG:

<grammar scope=“dialog” ><![CDATA[

#JSGF V1.0;
grammar command;
<command> = [remind me to] call | phone | telephone <name>
<when>;
<name> = bob | martha | joe | pete | chris | john | artoush;
<when> = today | this afternoon | tomorrow | next week;
]]>

</grammar>

In this example, the elements named <command>, <name>, and <when> are rules of the grammar. Rules are a combination of a rulename and an expansion of a rule that advises an ASR engine or a voice interpreter which words presently can be recognized. In this example, expansion includes conjunction and disjunction, and the vertical bars ‘|’ mean ‘or.’ An ASR engine or a voice interpreter processes the rules in sequence, first <command>, then <name>, then <when>. The <command> rule accepts for recognition ‘call’ or ‘phone’ or ‘telephone’ plus, that is, in conjunction with, whatever is returned from the <name> rule and the <when> rule. The <name> rule accepts ‘bob’ or ‘martha’ or ‘joe’ or ‘pete’ or ‘chris’ or ‘john’ or ‘artoush’, and the <when> rule accepts ‘today’ or ‘this afternoon’ or ‘tomorrow’ or ‘next week.’ The command grammar as a whole matches utterances like these, for example:
“phone bob next week,”
“telephone martha this afternoon,”
“remind me to call chris tomorrow,” and
“remind me to phone pete today.”

The voice server application (188) in this example is configured to receive, from a multimodal client located remotely across a network from the voice server, digitized speech for recognition from a user and pass the speech along to the ASR engine (150) for recognition. ASR engine (150) is a module of computer program instructions, also stored in RAM in this example. In carrying out automated speech recognition, the ASR engine receives speech for recognition in the form of at least one digitized word and uses frequency components of the digitized word to derive a Speech Feature Vector (‘SFV’). An SFV may be defined, for example, by the first twelve or thirteen Fourier or frequency domain components of a sample of digitized speech. The ASR engine can use the SFV to infer phonemes for the word from the language-specific acoustic model (108). The ASR engine then uses the phonemes to find the word in the lexicon (106).

Also stored in RAM is a VoiceXML interpreter (192), a module of computer program instructions that processes VoiceXML grammars. VoiceXML input to VoiceXML interpreter (192) may originate, for example, from VoiceXML clients running remotely on multimodal devices, from X+V clients running remotely on multimodal devices, from SALT clients running on multimodal devices, or from Java client applications running remotely on multimedia devices. In this example, VoiceXML interpreter (192) interprets and executes VoiceXML segments representing voice dialog instructions received from remote multimedia devices and provided to VoiceXML interpreter (192) through voice server application (188).

A multimodal application in a thin client architecture may provide voice dialog instructions, VoiceXML segments, VoiceXML <form> elements, and the like, to VoiceXML interpreter (149) through data communications across a network with multimodal application. The voice dialog instructions include one or more grammars, data input elements, event handlers, and so on, that advise the VoiceXML interpreter how to administer voice input from a user and voice prompts and responses to be presented to a user, including vocal help prompts. The VoiceXML interpreter administers such dialogs by processing the dialog instructions sequentially in accordance with a VoiceXML Form Interpretation Algorithm (‘FIA’) (193). In this example, the VoiceXML interpreter contains a VoiceXML dialog (522), where the dialog has been provided to the VoiceXML interpreter by a multimodal application to be interpreted by the VoiceXML interpreter.

Also stored in RAM (168) is an operating system (154). Operating systems useful in voice servers according to embodiments of the present invention include UNIX™, Linux™, Microsoft NT™, AIX™, IBM's i5/OS™, and others as will occur to those of skill in the art. Operating system (154), voice server application (188), VoiceXML interpreter (192), ASR engine (150), JVM (102), and TTS Engine (194) in the example of FIG. 2 are shown in RAM (168), but many components of such software typically are stored in non-volatile memory also, for example, on a disk drive (170).

Voice server (151) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in voice servers according to embodiments of the present invention include the Intel Northbridge, the Intel Memory Controller Hub, the Intel Southbridge, and the Intel I/O Controller Hub. Examples of expansion buses useful in voice servers according to embodiments of the present invention include Industry Standard Architecture (‘ISA’) buses and Peripheral Component Interconnect (‘PCI’) buses.

Voice server (151) of FIG. 2 includes disk drive adapter (172) coupled through expansion bus (160) and bus adapter (158) to processor (156) and other components of the voice server (151). Disk drive adapter (172) connects non-volatile data storage to the voice server (151) in the form of disk drive (170). Disk drive adapters useful in voice servers include Integrated Drive Electronics (‘IDE’) adapters, Small Computer System Interface (‘SCSI’) adapters, and others as will occur to those of skill in the art. In addition, non-volatile computer memory may be implemented for a voice server as an optical disk drive, electrically erasable programmable read-only memory (so-called ‘EEPROM’ or ‘Flash’ memory), RAM drives, and so on, as will occur to those of skill in the art.

The example voice server of FIG. 2 includes one or more input/output (‘I/O’) adapters (178). I/O adapters in voice servers implement user-oriented input/output through, for example, software drivers and computer hardware for controlling output to display devices such as computer display screens, as well as user input from user input devices (181) such as keyboards and mice. The example voice server of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary voice server (151) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for effecting functions on a multimodal telephony device according to embodiments of the present invention include modems for wired dial-up communications, Ethernet (IEEE 802.3) adapters for wired data communications network communications, and 802.11 adapters for wireless data communications network communications.

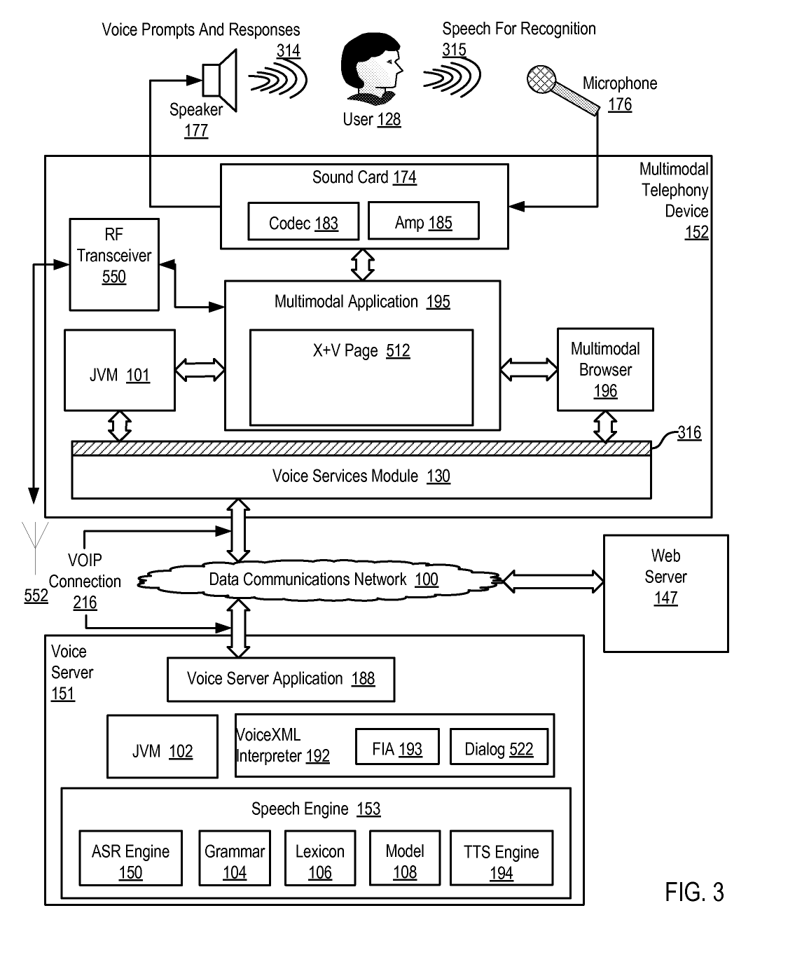

For further explanation, FIG. 3 sets forth a functional block diagram of exemplary system for effecting functions on a multimodal telephony device in a thin client architecture according to embodiments of the present invention. The example of FIG. 3 includes a multimodal telephony device (152) and a voice server (151) connected for data communication by a VOIP connection (216) through a data communications network (100). A multimodal application (195) runs on the multimodal device (152), and a voice server application (188) runs on the voice server (151). The multimodal client application (195) may be one or more of X+V or SALT documents that execute on multimodal browser (196), a Java voice application that executes on the Java Virtual Machine (101), or a multimodal application implemented in other technologies as may occur to those of skill in the art. The example multimodal telephony device of FIG. 3 also includes a sound card (174), which is an example of an I/O adapter specially designed for accepting analog audio signals from a microphone (176) and converting the audio analog signals to digital form for further processing by a codec (183).

In addition to the multimodal sever application (188), the voice server (151) also has installed upon it a speech engine (153) with an ASR engine (150), a grammar (104), a lexicon (106), a language-specific acoustic model (108), and a TTS engine (194), as well as a JVM (102), and a Voice XML interpreter (192). VoiceXML interpreter (192) interprets and executes VoiceXML dialog instructions received from the multimodal application and provided to VoiceXML interpreter (192) through voice server application (188). VoiceXML input to VoiceXML interpreter (192) may originate from the multimodal application (195) implemented as an X+V client running remotely on the multimodal device (152). As noted above, the multimedia device application (195) also may be implemented as a Java client application running remotely on the multimedia device (152), a SALT application running remotely on the multimedia device (152), and in other ways as may occur to those of skill in the art.

VOIP stands for ‘Voice Over Internet Protocol,’ a generic term for routing speech over an IP-based data communications network. The speech data flows over a general-purpose packet-switched data communications network, instead of traditional dedicated, circuit-switched voice transmission lines. Protocols used to carry voice signals over the IP data communications network are commonly referred to as ‘Voice over IP’ or ‘VOIP’ protocols. VOIP traffic may be deployed on any IP data communications network, including data communications networks lacking a connection to the rest of the Internet, for instance on a private building-wide local area data communications network or ‘LAN.’

Many protocols are used to effect VOIP. The two most popular types of VOIP are effected with the IETF's Session Initiation Protocol (‘SIP’) and the ITU's protocol known as ‘H.323.’ SIP clients use TCP and UDP port 5060 to connect to SIP servers. SIP itself is used to set up and tear down calls for speech transmission. VOIP with SIP then uses RTP for transmitting the actual encoded speech. Similarly, H.323 is an umbrella recommendation from the standards branch of the International Telecommunications Union that defines protocols to provide audio-visual communication sessions on any packet data communications network.

The apparatus of FIG. 3 operates in a manner that is similar to the operation of the system of FIG. 2 described above. Multimodal application (195) is a user-level, multimodal, client-side computer program that effects functions on a multimodal telephony device by receiving the speech of a telephone call; identifying with the automated speech recognition engine action keywords in the speech of the telephone call; selecting a function of the multimodal telephony device in dependence upon the action keywords; identifying parameters for the function of the multimodal telephony device; and executing the function of the multimodal telephony device using the identified parameters. The multimodal application of FIG. 3 is also capable of presenting a voice interface to user (128), providing audio prompts and responses (314) and accepting input speech for recognition (315). Multimodal application (195) provides a speech interface through which a user may provide oral speech for recognition through microphone (176) and have the speech digitized through an audio amplifier (185) and a coder/decoder (‘codec’) (183) of a sound card (174) and provide the digitized speech for recognition to ASR engine (150). Multimodal application (195) then packages the digitized speech in a recognition request message according to a VOIP protocol, and transmits the speech to voice server (151) through the VOIP connection (216) on the network (100).

Voice server application (188) provides voice recognition services for multimodal devices by accepting dialog instructions, VoiceXML segments, and returning speech recognition results, including text representing recognized speech, text for use as variable values in dialogs, and output from execution of semantic interpretation scripts—as well as voice prompts, including vocal help prompts according to embodiments of the present invention. Voice server application (188) includes computer program instructions that provide text-to-speech (‘TTS’) conversion for voice prompts and voice responses to user input in multimodal applications such as, for example, X+V applications, SALT applications, or Java Speech applications.

The voice server application (188) receives speech for recognition from a user and speech of a telephone call received on the multimodal telephony device (152) and passes the speech through API calls to VoiceXML interpreter (192) which in turn uses an ASR engine (150) for speech recognition. The ASR engine receives digitized speech for recognition, uses frequency components of the digitized speech to derive an SFV, uses the SFV to infer phonemes for the word from the language-specific acoustic model (108), and uses the phonemes to find the speech in the lexicon (106). The ASR engine then compares speech found as words in the lexicon to words in a grammar (104) to determine whether words or phrases in speech are recognized by the ASR engine.

The system of FIG. 3 operates generally to effect functions on a multimodal telephony device by receiving the speech of a telephone call; identifying with the automated speech recognition engine action keywords in the speech of the telephone call; selecting a function of the multimodal telephony device in dependence upon the action keywords; identifying parameters for the function of the multimodal telephony device; and executing the function of the multimodal telephony device using the identified parameters.

The multimodal application (195) is operatively coupled to a VoiceXML interpreter (192). In this example, the operative coupling between the multimodal application and the VoiceXML interpreter is implemented with a VOIP connection (216) through a voice services module (130). The voice services module is a thin layer of functionality, a module of computer program instructions, that presents an API (316) for use by an application level program in providing dialog instructions and speech for recognition to a VoiceXML interpreter and receiving in response voice prompts and other responses, including vocal help prompts according to embodiments of the present invention.

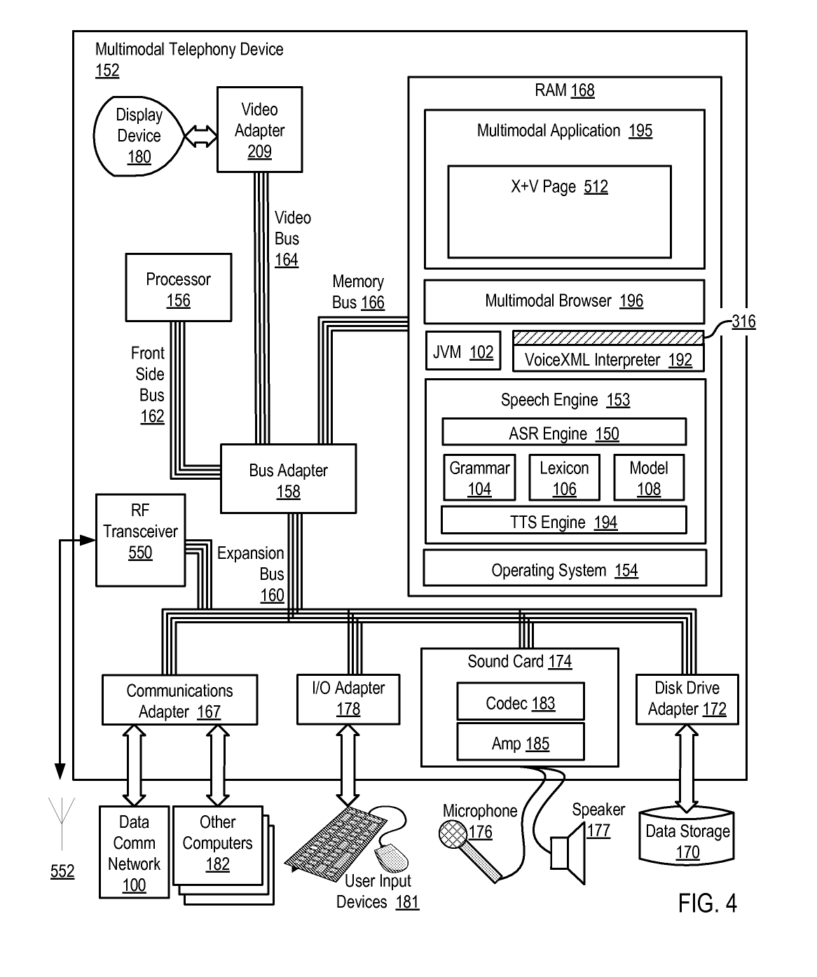

The voice services module (130) provides data communications services through the VOIP connection and the voice server application (188) between the multimodal device (152) and the VoiceXML interpreter (192). The API (316) is the same API presented to applications by a VoiceXML interpreter when the VoiceXML interpreter is installed on the multimodal device in a thick client architecture (316 on FIG. 4). So from the point of view of an application calling the API (316), the application is calling the VoiceXML interpreter directly. The data communications functions of the voice services module (130) are transparent to applications that call the API (316). At the application level, calls to the API (316) may be issued from the multimodal browser (196), which provides an execution environment for the multimodal application (195) when the multimodal application is implemented with X+V. And calls to the API (316) may be issued from the JVM (101), which provides an execution environment for the multimodal application (195) when the multimodal application is implemented with Java.

The multimodal telephony device (152) of FIG. 4 also has an antenna (552) and a Radio Frequency (‘RF’) transceiver (550) for cellular telephony communications. Radio Frequency (‘RF’) transceiver (550) is responsible for transmitting and receiving cellular communications for the multimodal telephony device. The multimodal telephony device sends and receives voice or data information via the antenna (552) over air to and from one or more cellular base stations.

Effecting functions on a multimodal telephony device according to embodiments of the present invention in thick client architectures is generally implemented with multimodal telephony devices, that is, automated computing machinery or computers. In the system of FIG. 1, for example, all the multimodal telephony devices (152) are implemented to some extent at least as computers. For further explanation, therefore, FIG. 4 sets forth a block diagram of automated computing machinery comprising an example of a computer useful as a multimodal telephony device (152) capable of effecting functions on a multimodal telephony device according to embodiments of the present invention. In a multimodal telephony device implementing a thick client architecture as illustrated in FIG. 4, the multimodal telephony device (152) has no connection to a remote voice server containing a VoiceXML interpreter and a speech engine. All the components needed for speech synthesis and voice recognition in effecting functions on a multimodal telephony device according to embodiments of the present invention are installed or embedded in the multimodal telephony device itself.

The example multimodal telephony device (152) of FIG. 4 includes several components that are structured and operate similarly as do parallel components of the voice server, having the same drawing reference numbers, as described above with reference to FIG. 2: at least one computer processor (156), frontside bus (162), RAM (168), high speed memory bus (166), bus adapter (158), video adapter (209), video bus (164), expansion bus (160), communications adapter (167), I/O adapter (178), disk drive adapter (172), an operating system (154), a JVM (102), a VoiceXML Interpreter (192), a speech engine (153), and so on. As in the system of FIG. 4, the speech engine in the multimodal device of FIG. 2 includes an ASR engine (150), a grammar (104), a lexicon (106), a language-dependent acoustic model (108), and a TTS engine (194). The VoiceXML interpreter (192) administers such dialogs by processing the dialog instructions sequentially in accordance with a VoiceXML Form Interpretation Algorithm (‘FIA’) (193).

The speech engine (153) in this kind of embodiment, a thick client architecture, often is implemented as an embedded module in a small form factor telephony device such as a mobile phone, a PDA that supports telephony functions, and the like. An example of an embedded speech engine useful for effecting functions on a multimodal telephony device according to embodiments of the present invention is IBM's Embedded ViaVoice Enterprise. The example multimodal telephony device of FIG. 4 also includes a sound card (174), which is an example of an I/O adapter specially designed for accepting analog audio signals from a microphone (176) and converting the audio analog signals to digital form for further processing by a codec (183). The sound card (174) is connected to processor (156) through expansion bus (160), bus adapter (158), and front side bus (162).

Also stored in RAM (168) in this example is a multimodal application (195), a module of computer program instructions capable of operating a multimodal device as an apparatus that supports effecting functions on a multimodal telephony device according to embodiments of the present invention. The multimodal application (195) implements speech recognition by accepting speech for recognition from a user and from a telephone call and sending the speech for recognition through API calls to the ASR engine (150). The multimodal application (195) implements speech synthesis generally by sending words to be used as prompts for a user to the TTS engine (194). As an example of thick client architecture, the multimodal application (195) in this example does not send speech for recognition across a network to a voice server for recognition, and the multimodal application (195) in this example does not receive synthesized speech, TTS prompts and responses, across a network from a voice server. All grammar processing, voice recognition, and text to speech conversion in this example is performed in an embedded fashion in the multimodal telephony device (152) itself.

More particularly, multimodal application (195) in this example is a user-level, multimodal, client-side computer program that provides a speech interface through which a user may provide oral speech for recognition through microphone (176), have the speech digitized through an audio amplifier (185) and a coder/decoder (‘codec’) (183) of a sound card (174) and provide the digitized speech for recognition to ASR engine (150). The multimodal application (195) may be implemented as one or more X+V documents executing in a multimodal browser (196) or microbrowser that passes VoiceXML grammars and digitized speech, received from a user and received from telephony calls, by calls through an API (316) directly to an embedded VoiceXML interpreter (192) for processing. The embedded VoiceXML interpreter (192) may in turn issue requests for speech recognition through API calls directly to the embedded ASR engine (150). Multimodal application (195) also can provide speech synthesis, TTS conversion, by API calls to the embedded TTS engine (194) for voice prompts and voice responses to user input, including dynamically generated vocal help prompts according to embodiments of the present invention.

In a further class of exemplary embodiments, the multimodal application (195) may be implemented as a Java voice application that executes on Java Virtual Machine (102) and issues calls through the VoiceXML API (316) for speech recognition and speech synthesis services. In further exemplary embodiments, the multimodal application (195) may be implemented as a set or sequence of SALT documents executed on a multimodal browser (196) or microbrowser that issues calls through the VoiceXML API (316) for speech recognition and speech synthesis services. In addition to X+V, SALT, and Java implementations, multimodal application (195) may be implemented in other technologies as will occur to those of skill in the art, and all such implementations are well within the scope of the present invention.

The multimodal telephony device (152) in this example is configured to effect functions on a multimodal telephony device according to embodiments of the present invention by receiving the speech of a telephone call; identifying with the automated speech recognition engine action keywords in the speech of the telephone call; selecting a function of the multimodal telephony device in dependence upon the action keywords; identifying parameters for the function of the multimodal telephony device; and executing the function of the multimodal telephony device using the identified parameters.

The multimodal application (195) is operatively coupled to a VoiceXML interpreter (192). In this example, the operative coupling between the multimodal application and the VoiceXML interpreter is implemented through the VoiceXML interpreter API (316). The VoiceXML interpreter API (316) is a module of computer program instructions for use by an application level program in providing dialog instructions and speech for recognition to a VoiceXML interpreter and receiving in response voice prompts and other responses, including vocal help prompts according to embodiments of the present invention. The VoiceXML interpreter API (316) presents the same application interface as is presented by the API of the voice service module (130 on FIG. 3) in a thin client architecture. At the application level, calls to the API (316) may be issued from the multimodal browser (196), which provides an execution environment for the multimodal application (195) when the multimodal application is implemented with X+V. And calls to the API (316) may be issued from the JVM (101), which provides an execution environment for the multimodal application (195) when the multimodal application is implemented with Java.

The multimodal application (195) in this example, running on a multimodal device (152) that contains its own VoiceXML interpreter (192) and its own speech engine (153) with no network or VOIP connection to a remote voice server containing a remote VoiceXML interpreter or a remote speech engine, is an example of a so-called ‘thick client architecture,’ so-called because all of the functionality for processing voice mode interactions between a user and the multimodal application—as well as all or most of the functionality for dynamically generating vocal help prompts according to embodiments of the present invention—is implemented on the multimodal device itself.

The multimodal telephony device (152) of FIG. 4 also has an antenna (552) and a Radio Frequency (‘RF’) transceiver (550) for cellular telephony communications. Radio Frequency (‘RF’) transceiver (550) is responsible for transmitting and receiving cellular communications for the multimodal telephony device. The multimodal telephony device sends and receives voice or data information via the antenna (552) over air to and from one or more cellular base stations.

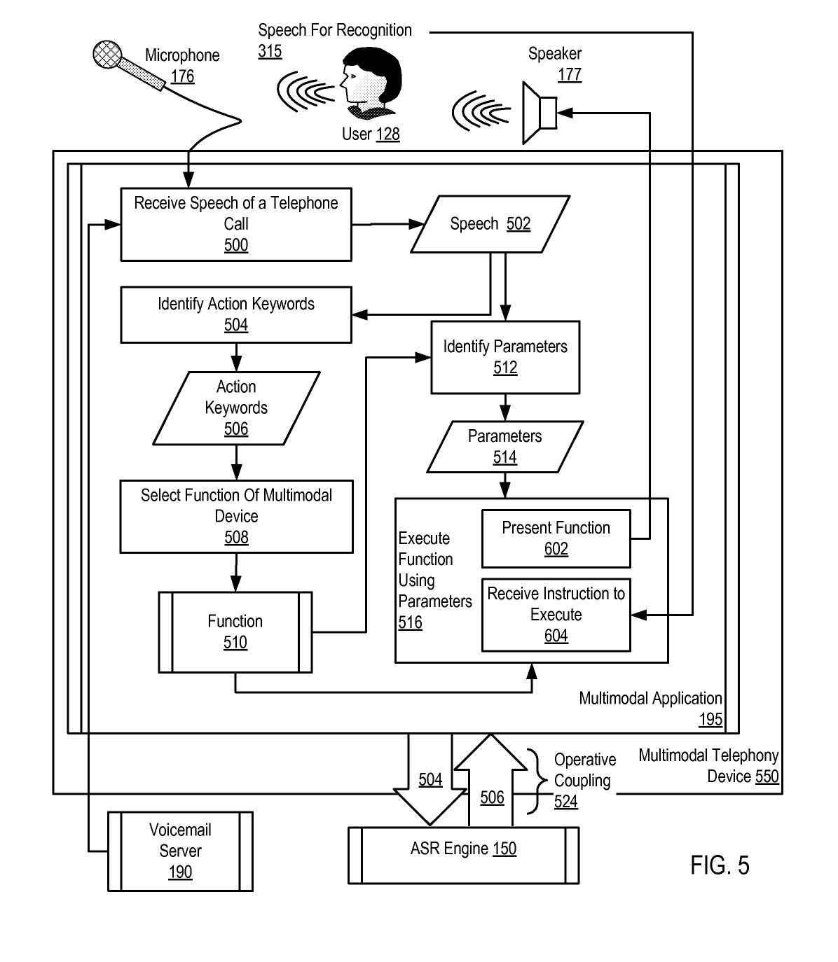

For further explanation, FIG. 5 sets forth a flow chart illustrating an exemplary method for effecting functions on a multimodal telephony device. The method of FIG. 5 is implemented with the multimodal application (195) operating on a multimodal telephony device (550) supporting multiple modes of interaction including a voice mode and one or more non-voice modes. The voice mode is represented in this example with audio output through a speaker (177) and audio input through a microphone (176). Non-voice modes are represented by user input devices (181), a keyboard and a mouse.

The multimodal application (195) of FIG. 5 is operatively coupled (524) to an automated speech recognition (‘ASR’) engine (150). The operative coupling (524) provides a data communications path (504) from the multimodal application to the ASR engine (150). The operative coupling may implement be an API (316 on FIG. 4) when the multimodal application is implemented in a thick client architecture, and the operative coupling may include an API (316 on FIG. 3), a voice service module (130 on FIG. 3), and a VOIP connection (216 on FIG. 3) when the multimodal application is implemented in a thin client architecture.

The method of FIG. 5 includes receiving (500) the speech (502) of a telephone call. Receiving (500) the speech (502) of a telephone call may be carried out by receiving in real time the speech of a telephone call in which a user (128) is actively participating. Alternatively, receiving (500) the speech (502) of a telephone call may be carried out by receiving a recorded message from, for example, a voice mail server.

As mentioned above, effecting functions on a multimodal telephony device according to the present invention is carried out using a speech recognition engine to identify action keywords for selecting one or more functions of the multimodal device. Effecting functions on a multimodal telephony device according to the present invention may therefore usefully use X+V pages having grammars. Receiving (500) the speech (502) of a telephone call therefore may include loading an X+V page in response to the telephone call. In some such examples, upon establishing a telephone call between two parties or upon initiating the receipt of a voicemail message, the multimodal application of FIG. 5 loads an X+V page containing one or more VoiceXML grammars designed to identify action keywords for effecting functions on the multimodal telephony device according to the present invention.

Action keywords include one or more words or phrases predetermined to be indicative of functions supported by the multimodal devices. For example, the keywords “phone number” may be indicative of a “Save Phonebook entry” function on the multimodal telephony device. Similarly, the action keyword “Friday” may be indicative of the “Save Calendar Entry” function on a multimodal telephony device.

The method of FIG. 5 also includes identifying (504) with the automated speech recognition engine action keywords (506) in the speech (502) of the telephone call and selecting (508) a function (510) of the multimodal telephony device (550) in dependence upon the action keywords (506). Identifying (504) action keywords (506) in the speech (502) of the telephone call using a speech recognition engine may be carried out by identifying an action keyword included in the one or more VoiceXML grammars of the loaded X+V page. Selecting (508) a function (510) of the multimodal telephony device (550) in dependence upon the action keywords (506) may be carried out by throwing an XML event identified in the X+V page in dependence upon the action keyword identified in the grammar.

The method of FIG. 5 also includes identifying (512) parameters (514) for the function (510) of the multimodal telephony device (550). A parameter for a function is the data used by a general function supported by the telephony device to implement an instance of the function's execution. For example, for the generic function “Save Phonebook Entry” the parameters needed to implement an instance of a phone book entry include one or more phone numbers and a name associated with those phone numbers. Identifying (512) parameters (514) for the function (510) of the multimodal telephony device (550) also may be carried out by identifying a phone number in dependence upon one or more VoiceXML grammars of the loaded X+V page.

For further explanation of selecting (508) a function (510) of the multimodal telephony device (550) in dependence upon the action keywords (506) and includes identifying (512) parameters (514) for the function (510) of the multimodal telephony device (550) according to the method of FIG. 5, consider the following grammar and XML event that selects a ‘Save Phonebook Entry’ function of the multimodal telephony device and saves a recognized phone number as a phonebook entry when the speech of a telephone call includes the words ‘call,’ ‘phone,’ ‘telephone,’ and includes a number predefined to be a telephone number:

<grammar scope=“dialog” ><![CDATA[
#JSGF V1.0;

<action_keyword> = ((call | phone | telephone) <number>){var e =
document.createEvent( “UIEvents” );
e.initEvent( “reco.phone.number”, “true”, “true” );
document.getElementById(“s1”).dispatchEvent( e ); }
<number> = digit+ {document.number = $;}
<digit> = 1|2|3|4|5|6|7|8|9|0;
</grammar>

<script id=“s1” ev:event=“reco.phone.number” >

return savePhoneBookEntry(document.number);

</script>

In the example above, upon matching the grammar rule, <action_keyword>, a script triggers an XML event “reco.phone.number” whose handler ‘s1’ calls a function that saves the phonebook entry. The phone number saved by the ‘savePhoneBookEntry’ function is identified by matching the grammar rule <number> with digits uttered in the speech of the telephone call. In the example above, those digits are assigned to the variable ‘document.number’ which is used to parameterize the function ‘savePhonebookEntry.’

The method of FIG. 5 also includes executing (516) the function (510) of the multimodal telephony device (550) using the identified parameters (514). Executing (516) the function (510) of the multimodal telephony device (550) using the identified parameters (514) gives effect to the function and may occurs without any user knowledge or user interaction.

Often effecting functions on a multimodal telephony device according to the present invention is carried out in parallel with the telephone call requiring no user intervention. That is, functions of the multimodal device are effected for the benefit of the user but without any user intervention. Alternatively, however, such as in the example of FIG. 5, executing (516) the function (510) of the multimodal telephony device (550) using the identified parameters (514) is carried out by presenting (602) to a user (128) an identification of the function (510) and the parameters (514) and receiving (604) from the user (128) an instruction to execute the function (510) using the identified parameters (514). Presenting (602) to a user (128) an identification of the function (510) and the parameters (514) and receiving (604) from the user (128) an instruction to execute the function (510) using the identified parameters (514) may be carried out through a voice mode and one or more non-voice modes of the multimodal device. As mentioned above, the voice mode is represented in this example with audio output through a speaker (177) and audio input through a microphone (176). Non-voice modes are represented by user input devices (181), a keyboard and a mouse.

In some cases, additional parameters may be provided by a user to better execute the identified function. Executing (516) the function (510) of the multimodal telephony device (550) using the identified parameters (514) therefore also may include receiving from a user unidentified parameters for executing the function. Such unidentified parameters are typically additional parameters or alternative parameters provided by a user to better execute the identified function. Receiving from a user unidentified parameters for executing the function may be carried out through a voice mode and one or more non-voice modes of the multimodal device.

In the example of FIG. 5, identifying (504) action keywords (506) in the speech (502) of the telephone call using a speech recognition engine; selecting (508) a function (510) of the multimodal telephony device (550) in dependence upon the action keywords (506); and identifying (512) parameters (514) for the function (510) of the multimodal telephony device (550) are carried out during the telephone call. That is, the steps of FIG. 5 are carried out during the playback of a message or during a real time phone call. This is for explanation, and not for limitation. In fact, alternatively, identifying (504) action keywords (506) in the speech (502) of the telephone call using a speech recognition engine; selecting (508) a function (510) of the multimodal telephony device (550) in dependence upon the action keywords (506); and identifying (512) parameters (514) for the function (510) of the multimodal telephony device (550) may be carried out after the telephone call as will occur to those of skill in the art.

The exemplary method of FIG. 5 is described largely using an example function of ‘Save Phonebook Entry’ supported by many telephony devices. This is for explanation, and not for limitation. The method of FIG. 5 may be used to effect many different functions supported by multimodal telephony devices, some of which are listed above, and all such functions are well within the scope of the present invention.

Exemplary embodiments of the present invention are described largely in the context of a fully functional computer system for effecting functions on a multimodal telephony device. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for effecting functions on a multimodal telephony device, the method implemented with the multimodal application operating on a multimodal telephony device supporting multiple modes of interaction including a voice mode and one or more non-voice modes, the multimodal application operatively coupled to an automated speech recognition engine, the method comprising:
receiving the speech of a telephone call;
identifying with the automated speech recognition engine action keywords in the speech of the telephone call;
selecting a function of the multimodal telephony device in dependence upon the action keywords;
identifying parameters for the function of the multimodal telephony device; and
executing the function of the multimodal telephony device using the identified parameters.

2. The method of claim 1 wherein:
identifying action keywords in the speech of the telephone call using a speech recognition engine; selecting a function of the multimodal telephony device in dependence upon the action keywords; and identifying parameters for the function of the multimodal telephony device are carried out during the telephone call.

3. The method of claim 1 wherein receiving the speech of a telephone call further comprises loading an X+V page in response to the telephone call, the X+V page including one or more VoiceXML grammars.

4. The method of claim 3 wherein identifying action keywords in the speech of the telephone call using a speech recognition engine further comprises identifying an action keyword included in the one or more VoiceXML grammars of the loaded X+V page.

5. The method of claim 3 wherein selecting a function of the multimodal telephony device in dependence upon the action keywords further comprises throwing an XML event identified in the X+V page in dependence upon the action keyword identified in the grammar.

6. The method of claim 1 wherein executing the function of the multimodal telephony device using the identified parameters further comprises:
presenting to a user an identification of the function and the parameters; and
receiving from the user an instruction to execute the function using the identified parameters.

7. Apparatus for effecting functions on a multimodal telephony device, the apparatus implemented with the multimodal application operating on a multimodal telephony device supporting multiple modes of interaction including a voice mode and one or more non-voice modes, the multimodal application operatively coupled to an automated speech recognition engine, the apparatus comprising a computer processor and a computer memory operatively coupled to the computer processor, the computer memory having disposed within it computer program instructions capable of:
receiving the speech of a telephone call;
identifying with the automated speech recognition engine action keywords in the speech of the telephone call;
selecting a function of the multimodal telephony device in dependence upon the action keywords;
identifying parameters for the function of the multimodal telephony device; and
executing the function of the multimodal telephony device using the identified parameters.

8. The system of claim 7 wherein computer program instructions capable of receiving the speech of a telephone call further comprise computer program instructions capable of loading an X+V page in response to the telephone call, the X+V page including one or more VoiceXML grammars.

9. The system of claim 8 wherein computer program instructions capable of identifying action keywords in the speech of the telephone call using a speech recognition engine further comprise computer program instructions capable of identifying an action keyword included in the one or more VoiceXML grammars of the loaded X+V page.

10. The system of claim 8 wherein computer program instructions capable of selecting a function of the multimodal telephony device in dependence upon the action keywords further comprise computer program instructions capable of throwing an XML event identified in the X+V page in dependence upon the action keyword identified in the grammar.

11. The system of claim 7 wherein computer program instructions capable of executing the function of the multimodal telephony device using the identified parameters further comprise computer program instructions capable of:
presenting to a user an identification of the function and the parameters; and
receiving from the user an instruction to execute the function using the identified parameters.

12. A computer program product for effecting functions on a multimodal telephony device, the computer program product comprising a multimodal application capable of operating on a multimodal telephony device supporting multiple modes of interaction including a voice mode and one or more non-voice modes, the multimodal application capable of operatively coupling to a speech recognition engine, the computer program product disposed upon a computer-readable medium, the computer program product comprising computer program instructions capable of:
receiving the speech of a telephone call;
identifying with the automated speech recognition engine action keywords in the speech of the telephone call;
selecting a function of the multimodal telephony device in dependence upon the action keywords;
identifying parameters for the function of the multimodal telephony device; and
executing the function of the multimodal telephony device using the identified parameters.

13. The computer program product of claim 12 wherein computer program instructions capable of receiving the speech of a telephone call further comprise computer program instructions capable of loading an X+V page in response to the telephone call, the X+V page including one or more VoiceXML grammars.

14. The computer program product of claim 13 wherein computer program instructions capable of identifying action keywords in the speech of the telephone call using a speech recognition engine further comprise computer program instructions capable of identifying an action keyword included in the one or more VoiceXML grammars of the loaded X+V page.

15. The computer program product of claim 12 wherein computer program instructions capable of selecting a function of the multimodal telephony device in dependence upon the action keywords further comprise computer program instructions capable of throwing an XML event identified in the X+V page in dependence upon the action keyword identified in the grammar.

16. The computer program product of claim 12 wherein computer program instructions capable of executing the function of the multimodal telephony device using the identified parameters further comprise computer program instructions capable of:
presenting to a user an identification of the function and the parameters; and
receiving from the user an instruction to execute the function using the identified parameters.

17. The computer program product of claim 12 wherein the computer readable medium comprises a recordable medium.

18. The computer program product of claim 12 wherein the computer readable medium comprises a transmission medium.
